(19) United States
(12) Patent Application Publication
(10) Pub. No.: US 2025/0106802 A1
(43) Pub. Date: Mar. 27, 2025

(54) METHODS AND SYSTEMS FOR HANDLING OF EDGE ENABLER CLIENT REGISTRATION DURING SERVICE CONTINUITY

(71) Applicant: Samsung Electronics Co., Ltd., Suwon-si, Gyeonggi-do (KR)

(72) Inventors: Sapan Pramodkumar SHAH, Bangalore (IN); Narendranath Durga TANGUDU, Bangalore (IN); Basavaraj Jayawant PATTAN, Bangalore (IN)

(21) Appl. No.: 18/728,752

(22) PCT Filed: Jan. 11, 2023
(86) PCT No.: PCT/KR2023/000522

§ 371 Date: Jul. 12, 2024

(30) Foreign Application Priority Data
Jan. 14, 2022 (IN) 202241002399
Sep. 5, 2022 (IN) 2022 41002399

(51) Int. Cl. H04W 60/02; H04L 67/55; H04W 8/00

(52) U.S. Cl. CPC H04W 60/02; H04L 67/55; H04W 8/005

(57) ABSTRACT

The disclosure relates to a 5G or 6G communication system for supporting a higher data transmission rate. Embodiments herein disclose method for handling a registration of an EEC (600) during a service continuity procedure by a Target-Edge Enabler Server (T-EES) (400). The method includes performing an implicit registration of the EEC (600) upon receiving a push EEC context request message from a Source-Edge Enabler Server (S-EES) (300). Further, the method includes creating at least one of a registration ID associated with the implicit registration and an expiration time associated with the implicit registration of the EEC (600). Further, the method includes adding at least one of the registration ID and the expiration time in a push EEC context response message. Further, the method includes sending the push EEC context response message comprising at least one of the registration ID and the expiration time to the S-EES (300).

### TECHNICAL FIELD

Embodiments disclosed herein relate to wireless communication networks and more particularly to managing edge enabler clients in the wireless communication networks (e.g., edge data networks or the like).

### BACKGROUND ART

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHZ and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service. Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Technical Problem

One of the important benefits of fifth generation (5G) network is to increase the speed of a data transfer by reducing the latency. Edge computing allows to reduce the latency by enabling services to be hosted close to the service consumers. The edge computing provides benefits such as efficient service delivery with significant reduction in end-to-end latency and decreased load on a transport network.

In 3rd Generation Partnership Project technical specification (3GPP TS) 23.558, the 3GPP has defined an architecture for enabling Edge Applications. For the edge computing, it is essential that Application Clients are able to locate and connect with the most suitable Edge Application Server (EAS) available in the Edge Data Network (EDN), depending on the needs of the application. In an Edge Enabler Layer (EEL), the Edge Enabler Server (EES) located in the network, and the Edge Enabler Client (EEC) in located in a User Equipment (UE), exposes APIs to support capabilities to enable the Application Client (AC) and EASs to provide and consume services at the edge. One of such capability is to support for service continuity.

With UE mobility, the serving edge may change or new edge become more suitable for serving the AC. In order to enable continuity of service in such cases, the 3GPP defined architecture supports transfer of the UE's application context information between the Edge networks for seamless service continuity. In service continuity procedures, the application context residing in Edge Application Server (EAS) is transferred from a source EAS (S-EAS) to a target EAS (T-EAS). Further, the EEC context is also relocated from the Source EES (S-EES) to the Target EES (T-EES).

The 3GPP has defined different service continuity scenarios-depending on the different entities detecting, deciding and executing the Application Context Relocation (ACR) during service continuity. Following are two of such scenarios:
1. In S-EAS decided ACR scenario, the Source Edge Application Server (EAS) may detect the need of ACR locally or is notified by the Source Edge Enabler Server (EES) via ACR management notifications in “ACR monitoring” events. The S-EAS makes the decision about whether to perform the ACR, and starts the ACR at a proper time.
2. In S-EES executed ACR scenario, the S-EES detects, decides and executes ACR from the Source EAS to the Target EAS.

In both S-EAS decided ACR and S-EES executed ACR scenarios, a successful EEC context relocation procedure enables the EEC to become implicitly registered to the target EES without the EEC sending an explicit EEC registration request.

As there is no explicit registration request from the EEC, and the EEC is not implicitly registered at the T-EES for all the service continuity scenarios, it is not known to T-EES whether to perform implicit registration of the EEC or not. Without such information, the EEC may not be registered at the T-EES even after successful EEC context relocation.

The registration ID is used to identify the registration at the EEC, which will be used by the EEC for to perform registration related procedures like update registration. The EES assigns registration identity to the EEC registration information upon successful registration. However, as EEC becomes implicitly registered with the T-EES in both S-EAS decided ACR and S-EES executed ACR scenarios, the EEC is unaware of the new registration id assigned by the T-EES upon implicit EEC registration after a successful EEC context relocation. Further, the EEC is unaware of the registration expiration time also. The registration ID is one of the important parameter for the EEC to communicate with the EES, and without the registration ID, the EEC will not be able to update registration to provide new AC profiles or will not be able to deregister itself from the EES once Edge service are not needed-which will lead to unnecessary resource occupation and non-availability of the Edge services.

FIG. 1 illustrates the sequence of procedures for the EEC (600 (as shown in FIG. 2-FIG. 4)) which is a part of UE (500), to access service from the EAS and further sequence of procedures during service continuity. Here, the S-EES (300) is the EES where the EEC (600) is first registered. The S-EAS (100) is the EAS which is selected by the EEC (600) or the AC to receive application service after registration with the S-EES (300). The T-EAS (200) is the EAS which will be served the EEC (600)/AC at the new location after the UE's movement. T-EES (400) is the EES where EEC (600) will be registered at the new location after the UE's movement.

In step 1, the application service providers (ASPs) deploy the EAS into an edge data network (EDN (1000a or 1000b)) and registers its services to the EES as specified in the clause 8.4.3 of TS 23.558. The EES maintains the EAS details which will be used during EAS discovery from the EEC (600).

In step 2, upon boot up or based on trigger from the AC, the EEC (600) (in the UE (500)) registers itself with the EES as specified in the clause 8.4.2 of TS 23.558. The EEC (600) provides security credentials, list of AC profiles and supported service continuity scenarios. The EES verifies the security credentials of the EEC (600), further determines whether the requirements that were indicated in the AC Profile(s) can be fulfilled and reserves corresponding resources. Upon successful registration, the EES provides the registration ID to the EEC which will be used by the EEC (600) to update the registration or to deregister from the EES.

In step 3, upon successful registration, the EEC (600) sends a request to the EES to discover list of Edge application servers which can serve the Applications on the UE (500). Based on the filter criteria provided in the EAS discovery request, the EES sends the list of EASs to the EEC (600).

In step 4, based on the list of EASs received in the EAS discovery response, either the EEC (600) or the AC selects the EAS to use to receive the service. The application client connects to the Edge Application server and consumes the service.

In step 5, while consuming service from the EAS (i.e., S-EAS (100)), the UE (500) is moving out of coverage of the EDN (1000a).

In step 6, the S-EAS (100) detects the need for the service continuity and decides to execute ACR procedure, or the S-EES (300) detects and decides to execute the ACR procedure. During ACR procedure, multiple steps are executed. One of the step is application context transfer (ACT) from the S-EAS (100) to the T-EAS (200). Further, the S-EES (300) also pushes the EEC context to the T-EES (400), applies the AF traffic influence with the N6 routing information of the T-EAS (200) in the 3GPP Core Network, and sends notifications to the EAS and EEC (600) about the status of the ACR. Once ACR procedure is successfully completed, that is, the application client in UE (500) starts using services from the T-EAS (200), the EEC (600) is considered to be implicit registered with the T-EES (400) without the EEC (600) sending an EEC registration request to the T-EES (400).

Although, the EEC is implicitly registered with T-EES, the EEC (600) is not informed about the new registration ID assigned by the T-EES (400) and also expiration time.

Occurrence of such issues will break the edge enabler layer capacities, and the EAS service towards the application client. Occurrence of such issues can also reduce the customer satisfaction.

Thus, it is desired to address the above mentioned disadvantages or other shortcomings or at least provide a useful alternative.

### Solution to Problem

Accordingly, the embodiments herein provide methods for handling a registration of an edge enabler client (EEC) during a service continuity procedure. The method includes performing, by a Target-Edge Enabler Server (T-EES), an implicit registration of the EEC upon receiving a push EEC context request message from a Source-Edge Enabler Server (S-EES). Further, the method includes creating, by the T-EES, at least one of a registration identifier (ID) associated with the implicit registration and an expiration time associated with the implicit registration of the EEC. Further, the method includes adding, by the T-EES, at least one of the registration ID and the expiration time in a push EEC context response message. Further, the method includes sending, by the T-EES, the push EEC context response message comprising at least one of the registration ID and the expiration time to the S-EES.

In an embodiment, the registration ID corresponds to a registration of the EEC and the expiration time indicates an expiration time of the registration of the EEC.

Accordingly, the embodiments herein provide methods for handling a registration of an EEC during a service continuity procedure. The method includes sending, by a S-EES, a push EEC context request message to a T-EES. Further, the method includes receiving, by the S-EES, a push EEC context response message comprising at least one of a registration ID associated with an implicit registration of the EEC and an expiration time associated with the implicit registration of the EEC from the T-EES based on the push EEC context request message.

In an embodiment, the method includes performing, by the S-EES, at least one of storing at least one of the registration ID and the expiration time at the S-EES, and notifying at least one of the registration ID corresponding to the implicit registration of the EEC and the expiration time while sending an ACR information notification to the EEC.

Accordingly, the embodiments herein provide methods for handling a registration of an EEC during a service continuity procedure. The method includes performing, by a T-EES, an implicit registration of the EEC upon receiving a push EEC context request message from a S-EES. Further, the method includes creating, by the T-EES, at least one of a registration ID associated with the implicit registration and an expiration time associated with the implicit registration of the EEC. Further, the method includes adding, by the T-EES, at least one of the registration ID and the expiration time in a notification. Further, the method includes sending, by the T-EES, the notification comprising at least one of the registration ID and the expiration time to the EEC using a notification target address.

In an embodiment, the notification including at least one of the registration ID and the expiration time is sent to the EEC upon the EEC sending a EES registration request to the S-EES.

In an embodiment, the S-EES receives the EES registration request from the EEC and stores information included in the EES registration request.

In an embodiment, the information includes at least one of an EEC service continuity support, at least one EEC context, and a notification target address.

In an embodiment, the push EEC context request message includes a flag, where the flag indicates to the T-EES about at least one of implicitly registration the EEC for which a EEC context is pushed, the EEC is unaware of context push, a S-EAS triggered context push and a S-EES triggered context push.

Accordingly, the embodiments herein provide methods for handling a registration of an EEC during a service continuity procedure. The method includes performing, by a T-EES, an implicit registration of the EEC upon receiving a push EEC context request message from a S-EES. Further, the method includes creating, by the T-EES, at least one of a registration ID associated with the implicit registration and an expiration time associated with the implicit registration of the EEC. Further, the method includes receiving, by the T-EES, at least one message from the EEC, where at least one message obtains an update of the registration. Further, the method includes adding, by the T-EES, at least one of the registration ID and the expiration time in the at least one message. Further, the method includes sending, by the T-EES, the at least one message comprising at least one of the registration ID, the expiration time and a cause value to the EEC.

In an embodiment, the cause value indicates that at least one of an EEC registration does not exist on the T-EES, the EEC registration is expired and perform explicit registration to the T-EES by the EEC.

In an embodiment, the push EEC context request message comprising a flag, wherein the flag indicates to the T-EES about at least one of implicitly registration the EEC for which an EEC context is pushed, the EEC is unaware of context push, a S-EAS triggered context push and a S-EES triggered context push.

In an embodiment, receiving, by the T-EES, at least one message from the EEC includes sending, by the EEC, at least one message to a T-EES, wherein at least one message obtains an update of the registration, and receiving, by the EEC, the at least one message comprising at least one of the registration ID, the expiration time and a cause value from the T-EES.

Accordingly, the embodiments herein provide a T-EES for handling a registration of an EEC during a service continuity procedure. The T-EES includes a service continuity procedure controller coupled with a processor and a memory. The service continuity procedure controller is configured to perform an implicit registration of the EEC upon receiving a push EEC context request message from a S-EES. The service continuity procedure controller is configured to create at least one of a registration ID associated with the implicit registration and an expiration time associated with the implicit registration of the EEC. Further, the service continuity procedure controller is configured to add at least one of the registration ID and the expiration time in a push EEC context response message. Further, the service continuity procedure controller is configured to send the push EEC context response message comprising at least one of the registration ID and the expiration time to the S-EES.

Accordingly, the embodiments herein provide a S-EES for handling a registration of an EEC during a service continuity procedure. The S-EES includes a service continuity procedure controller coupled with a processor and a memory. The service continuity procedure controller is configured to send a push EEC context request message to a T-EES. Further, the service continuity procedure controller is configured to receive a push EEC context response message comprising at least one of a registration identifier (ID) associated with an implicit registration of the EEC and an expiration time associated with the implicit registration of the EEC from the T-EES based on the push EEC context request message.

Accordingly, the embodiments herein provide a T-EES for handling a registration of an EEC during a service continuity procedure. The T-EES includes a service continuity procedure controller coupled with a processor and a memory. The service continuity procedure controller is configured to perform an implicit registration of the EEC upon receiving a push EEC context request message from a S-EES. Further, the service continuity procedure controller is configured to create at least one of a registration ID associated with the implicit registration and an expiration time associated with the implicit registration of the EEC. Further, the service continuity procedure controller is configured to add at least one of the registration ID and the expiration time in a notification. Further, the service continuity procedure controller is configured to send the notification comprising at least one of the registration ID and the expiration time to the EEC using a notification target address.

Accordingly, the embodiments herein provide a T-EES for handling a registration of an EEC during a service continuity procedure. The T-EES includes a service continuity procedure controller coupled with a processor and a memory. The service continuity procedure controller is configured to perform an implicit registration of the EEC upon receiving a push EEC context request message from a S-EES. Further, the service continuity procedure controller is configured to create at least one of a registration identifier (ID) associated with the implicit registration and an expiration time associated with the implicit registration of the EEC. Further, the service continuity procedure controller is configured to receive at least one message from the EEC, wherein at least one message obtains an update of the registration. Further, the service continuity procedure controller is configured to add at least one of the registration ID and the expiration time in the at least one message. Further, the service continuity procedure controller is configured to send the at least one message comprising at least one of the registration ID, the expiration time and a cause value to the EEC.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### Advantageous Effects of Invention

The principal object of the embodiments herein is to disclose methods and systems for handling of edge enabler client registration during service continuity. The method can be used to improve operations of edge enabler layer and reduce a service interruptions so as to increase an end user experience and service satisfaction.

Another object of the embodiments herein is to provide an indication from a S-EES towards a T-EES to inform the T-EES to perform implicit registration of an EEC.

Another object of the embodiments herein is to generate the registration ID by T-EES to perform implicit registration of the EEC.

Another object of the embodiments herein is to inform new registration ID and expiration time to the S-EES in an EEC context push response.

Another object of the embodiments herein is to notify the EEC by the S-EES about new registration ID and expiration time in an ACR information notification.

Another object of the embodiments herein is to include a notification target address in a EEC registration request to receive notification related to EEC registration.

Another object of the embodiments herein is to store and maintain the EEC notification target address in the EEC context.

Another object of the embodiments herein is to notify the EEC by the T-EES about new registration Id using notification target address.

### BRIEF DESCRIPTION OF DRAWINGS

The embodiments disclosed herein are illustrated in the accompanying drawings, throughout which like reference letters indicate corresponding parts in the various figures. The embodiments herein will be better understood from the following description with reference to the drawings, in which:

FIG. 1 illustrates the sequence of procedures for EEC to access service from EAS and further sequence of procedures during service continuity, according to prior arts;

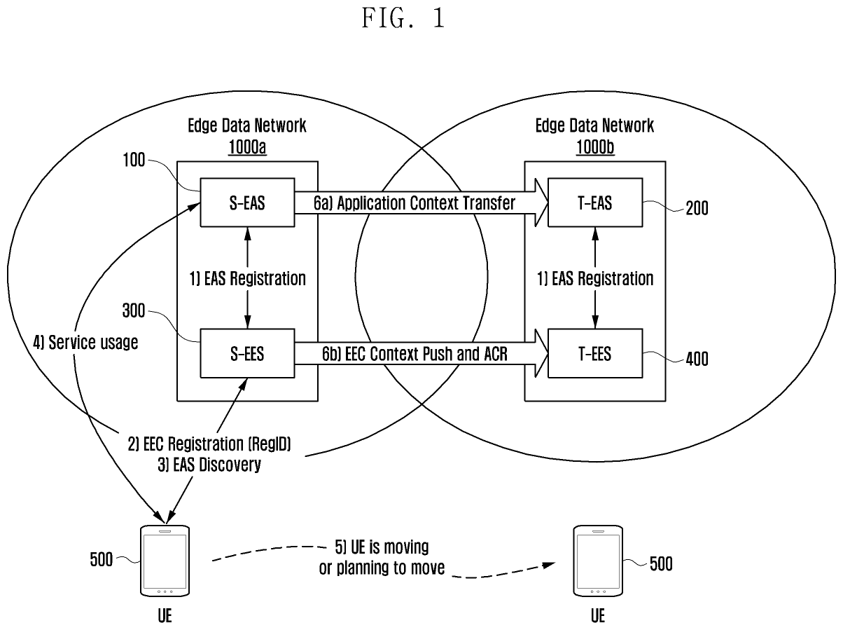

FIG. 2 illustrates various operations to inform new registration details created at a T-EES to a EEC through EEC context push and ACR information notification procedures, according to embodiments as disclosed herein;

FIG. 3 depicts another various operations to inform new registration details created at the T-EES to the EEC by using direct notification from the T-EES to the EEC, according to embodiments as disclosed herein;

FIG. 4 depicts another various operations to inform new registration details created at T-EES to the EEC by using EEC registration fetch procedure, according to embodiments as disclosed herein;

FIG. 5 shows various hardware components of the T-EES, according to the embodiments as disclosed herein;

FIG. 6 shows various hardware components of the S-EES, according to the embodiments as disclosed herein;

FIG. 7 is a flow chart illustrating a method, implemented by the S-EES, for handling the registration of the EEC during the service continuity procedure, according to the embodiments as disclosed herein; and

FIG. 8 is a flow chart illustrating a method, implemented by the T-EES, for handling the registration of the EEC during the service continuity procedure, according to the embodiments as disclosed herein.

FIG. 9 is another flow chart illustrating a method, implemented by the T-EES, for handling the registration of the EEC during the service continuity procedure, according to the embodiments as disclosed herein.

FIG. 10 is another flow chart illustrating a method, implemented by the T-EES, for handling the registration of the EEC during the service continuity procedure, according to the embodiments as disclosed herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

The embodiments herein achieve methods for handling a registration of an EEC during a service continuity procedure. The method includes performing, by a T-EES, an implicit registration of the EEC upon receiving a push EEC context request message from a S-EES. Further, the method includes creating, by the T-EES, at least one of a registration ID associated with the implicit registration and an expiration time associated with the implicit registration of the EEC. Further, the method includes adding, by the T-EES, at least one of the registration ID and the expiration time in a push EEC context response message. Further, the method includes sending, by the T-EES, the push EEC context response message comprising at least one of the registration ID and the expiration time to the S-EES.

The method can be used to improve operations of Edge enabler layer and reduce a service interruptions so as to increase an end user experience and service satisfaction.

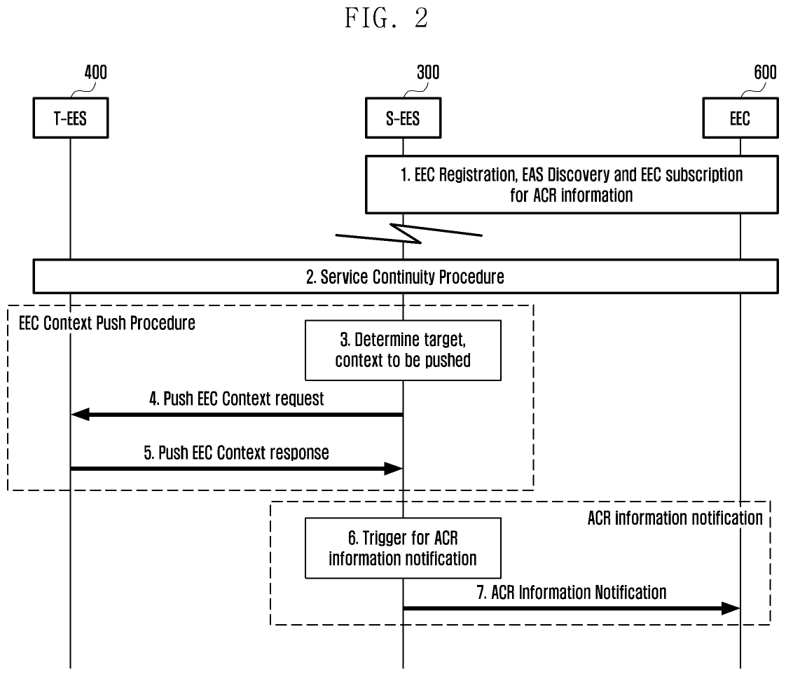

Referring now to the drawings, and more particularly to FIGS. 2 through 10, where similar reference characters denote corresponding features consistently throughout the figures, there are shown at least one embodiment.

FIG. 2 illustrates various operations to inform new registration details created at the T-EES (400) to the EEC (600) by modifying the EEC context push and ACR information notification procedures. In step 1, the EEC (600) is registered with the S-EES (300) and has discovered the S-EAS (100) from where the AC (in the UE (500)) is receiving the service. Further, the EEC (600) has also subscribed for ACR information to the S-EES (300). In step 2, either S-EAS (100) decided ACR or S-EES executed ACR procedure is initiated as specified in clause 8.8.2.4 or clause 8.8.2.5 respectively.

In step 3, the source EES (300) determines to forward EEC Context for relocation to a target EES (400). The source EES (300) determines the target EES and the EEC context to be forwarded. In step 4, the source EES (300) sends the push EEC context request to the target EES (400) including the EEC context determined. If the request (i.e., EEC context push request) is initiated
a) either after selected T-EAS declaration message from the S-EAS (100) (for S-EAS decided ACR) or after the S-EES (300) determines the T-EES (400) and the T-EAS (200) via the Discover T-EAS procedure (for S-EES executed ACR); or
b) by S-EAS decided ACR or S-EES executed ACR;

The S-EES (300) includes a flag in the request message to indicate the T-EES (400):
a) to implicitly register the EEC (600) for which the EEC context is pushed; or
b) that the EEC (for which the EEC context is pushed) is unaware of context push;
c) about S-EAS (100) or S-EES triggered context push.

TABLE 1

| Information | | |
|---|---|---|
| element | Status | Description |
| EES ID | Mandatory | Unique identifier of the requesting EES. |
| | (M) | |
| Security | M | Security credentials resulting from a |
| credentials | | successful authorization for the edge |
| | | computing service. |
| EEC Context | M | EEC Context |
| flag (NOTE 1) | Optional | Indicates T-EES that EEC is unaware of |
| | (O) | context push |
| | | Or |
| | | Indicates T-EES to implicitly register the |
| | | EEC for which EEC context is pushed. |
| | | Or |
| | | Indicates T-EES about S-EAS or S-EES |
| | | triggered context push |
| | | Or |
| | | Any other similar indication to indicate S- |
| | | EAS decided ACR scenario or S-EES |
| | | executed ACR scenario |

(NOTE 1):
This IE is included if this request (i.e. EEC context push request) is initiated either after selected T-EAS declaration message from S-EAS or after S-EES determines T-EES and T-EAS via the Discover T-EAS procedure. Or This IE is included when EEC is unaware of EEC context push Or This IE is included when EEC context push is initiated by S-EAS or S-EES. That is this request (i.e. EEC context push request) is initiated for S-EAS decided ACR or S-EES executed ACR scenarios.

Table 1 describes information elements in the EEC Context Push request between two EESs (300 and 400).

In step 5, upon receiving the request from the source EES (300), the target EES (400) validates the request and verifies the security credentials. The target EES (400) uses the EEC context ID provided to authorize the EEC context to be stored and managed. Then the target EES (400) sends an EEC context response indicating success. If the flag is included in the request message, the T-EES (400) performs implicit registration for the EEC (600) (whose EEC context is received in the request message) and creates the registration ID for the registration. If the flag is present in the request message and if the implicit registration is a success, the target EES (400) includes an implicit registration status along with the registration ID and expiration time in the push EEC context response message. If the flag is present in the request message and if the implicit registration fails (for any unknown reason), the T-EES (400) includes the implicit registration status as failed. Table 2 describes information elements in the EEC Context Push request between two EESs (300 and 400).

TABLE 2

| Information | | |
|---|---|---|
| element | Status | Description |
| Successful | O | Indicates that the request was successful. |
| response | | |
| Implicit | O | Indicates whether implicit registration is |
| Registration | | successful or not; |
| status | | This IE is included if the flag is present in |
| | | the request message (for S-EAS decided |
| | | ACR or S-EES executed ACR scenarios). |
| >registration | O | Identifier of the registration for the EEC. |
| ID | | This IE is included if the Implicit |
| | | Registration status is success. |
| >Expiration | O | Indicates the expiration time of the |
| time | | registration. This IE is included if the |
| | | Implicit Registration status is success. |
| Failure | O | Indicates that the request failed. |
| response | | |
| >Cause | O | Indicates the cause of request failure, |
| | | mandatory if the request failed. |

In an embodiment, T-EES (400) performs implicit registration and creates the registration ID for the registration and includes it in the EEC context push response message for S-EAS decided ACR or S-EES executed ACR scenarios.

Steps 3 to 5 are part of EEC context push relocation procedure as specified in clause 8.9.2.3 of 3GPP TS 23.558.

NOTE: For S-EAS decided ACR, based on the T-EAS selection information received from the S-EAS, the S-EES (300) sends the target information notification to the EEC (600) (as described in clause 8.8.3.5.3). For S-EES executed ACR, the S-EES (300) sends the target information notification to the EEC (600) (as described in clause 8.8.3.5.3).

In step 6, an event (e.g., ACR complete, or Target information notification) occurs at the EES that satisfies trigger conditions for providing ACR information to a subscribed EEC (600).

In step 7, the EES sends an ACR information notification to the EEC (600) with the ACR information (as determined in step 1). The ACR information notification may include ACID to indicate the application context relocation of the AC is complete. If the S-EES (300) has received the successful Implicit Registration Status from T-EES (400) along with registration ID and expiration time in the EEC context push relocation procedure, the ACR information notification towards EEC (600) also includes the Implicit Registration Status along with the registration ID and expiration time. If the Implicit Registration Status from T-EES (400) in the EEC context push relocation procedure indicates the failure, the ACR information notification towards EEC also includes the implicit registration status as failed. Table 3 describes the information elements for ACR information notification from the EES to the EEC (600). The S-EES (300) may include the Implicit Registration Status along with registration ID and expiration time for both target information notification or ACR complete notification or any one of them. If the Implicit Registration Status indicates that the implicit registration of the EEC (600) was not successful, then the EEC performs the required EEC registration at the T-EES (400).

TABLE 3

| Information | | |
|---|---|---|
| element | Status | Description |
| Subscription | M | Subscription identifier corresponding to the |
| ID | | subscription stored in the EES for the |
| | | request |
| EASID | M | The identifier of the EAS |
| ACID | O | The identifier of the AC corresponding to |
| | | the Selected target EAS |
| Event ID | M | Either Target information notification or |
| | | ACR complete |
| Target | O | Details of the selected T-EAS and the T- |
| information | | EES. |
| (NOTE 1) | | |
| >T-EAS | M | Details of the selected T-EAS as described |
| information | | in ‘Discovered EAS’ IE of Table 8.5.3.3-1. |
| >T-EES | O | Details of the selected T-EES as described |
| information | | in ‘EDN configuration information’ IE of |
| (NOTE 4) | | Table 8.3.3.3.3-1. |
| Implicit | O | Indicates whether EEC has been implicitly |
| Registration | | registered or not. |
| Status | | |
| (NOTE 6) | | |
| >Registration | O | Identifier of the registration for the EEC. |
| Id (NOTE | | This IE is included if the Implicit |
| 6) | | Registration status is success. |
| >Expiration | O | Indicates the expiration time of the |
| Time | | registration. This IE is included if the |
| | | Implicit Registration status is success. |
| Result | O | Indicates whether the ACR is successful or |
| of ACR | | failure |
| (NOTE 2) | | |
| EEC Context | O | Indicates whether the EEC context |
| Relocation | | relocation was successful or not. |
| status | | |
| (NOTE 5) | | |
| Cause | O | Indicates the cause information for the |
| information | | failure |
| (NOTE 3) | | |

(NOTE 1):
This IE shall be included when Event ID indicates ‘Target information notification’ event
(NOTE 2):
This IE shall be included when Event ID indicates ‘ACR complete’ event
(NOTE 3):
This IE shall be included when the Result of ACR indicates failure.
(NOTE 4):
This IE shall be included if the selected T-EES is different from the S-EES. Otherwise, it may be skipped.
(NOTE 5):
This IE shall be included when Event ID indicates ‘ACR complete’ event and EEC context relocation was attempted.
(NOTE 6):
This IE shall be included when S-EES has received the Implicit Registration Status from T-EES in EEC Context Push relocation procedure

Steps 6 to 7 are part of ACR information notification procedure as specified in clause 8.8.3.5.3 of 3GPP TS 23.558.

In an embodiment, for S-EAS decided ACR or S-EES executed ACR scenarios, the ACR information notification towards the EEC (600) also includes the Implicit Registration Status along with the registration ID and expiration time, as received by the S-EES (300) from the T-EES (400) in the EEC context push relocation procedure.

In an embodiment, the S-EES (300) notifies the EEC (600) about the new registration ID using the notification target address received during first EEC registration with the S-EES (300).

In an embodiment, once the T-EES (400) receives the ACR status update request from the T-EAS (200) indicating successful ACT, the T-EES (400) determines to perform implicit registration of the EEC (600) based on timer or other criteria.

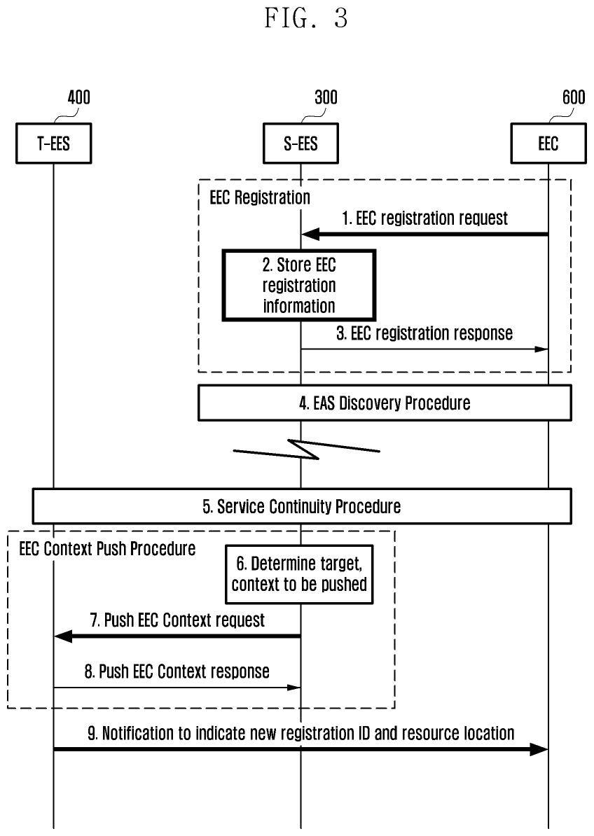

FIG. 3 depicts another various operations to inform new registration details created at the T-EES (400) to the EEC (600) by using direct notification from the T-EES (400) to the EEC (600).

In step 1, the EEC (600) sends the EEC registration request to the S-EES (300). The request from the EEC (600) includes the EES profile and EES security credentials. The request may include a proposed expiration time for the registration. The request includes notification destination address to receive notification related to EEC registration updates (like new registration details after successful ACR). Table 4 describes information elements for an EEC registration request from the EEC (600) to the S-EES (300).

TABLE 4

| Information | | |
|---|---|---|
| element | Status | Description |
| EECID | M | Unique identifier of the EEC. |
| UE Identifier | O | The identifier of the hosting UE (i.e. |
| | | GPSI or identity token) |
| Security | M | Security credentials resulting from a |
| credentials | | successful authorization for the edge |
| | | computing service. |
| AC Profile(s) | O | Profiles of ACs for which the EEC provides |
| | | edge enabling services. AC Profiles are |
| | | further described in Table 8.2.2-1. |
| EEC Service | O | Indicates if the EEC supports service |
| Continuity | | continuity or not. The IE also indicates |
| Support | | which ACR scenarios are supported by the |
| | | EEC. |
| Proposed | O | Proposed expiration time for the |
| expiration time | | registration. |
| Notification | M | The Notification target address (e.g. URL) |
| Target | | where the notifications destined for the EEC |
| Address | | regarding registration updates should be |
| | | sent to. |
| EEC context | O | Identifier of the EEC context obtained from |
| ID (NOTE) | | a previous registration. |
| Source EESID | O | Identifier of the EES that provided EEC |
| (NOTE) | | context ID. |
| Source EES | O | The endpoint address (e.g. URI, IP address) |
| Endpoint | | of the EES that provided EEC context ID. |
| (NOTE) | | |

(NOTE):
This IE shall not be present when EEC registration is performed as part of
ACR.

In step 2, upon receiving the request from the EEC (600), the S-EES (300) verifies the security credentials of the EEC (600) and stores the EEC registration information (obtained in step 1). The EEC context includes information about an EEC (600) for receiving edge enabler services. Table 5 depicts the EEC context.

TABLE 5

| Information | | |
|---|---|---|
| element | Status | Description |
| EEC ID | M | Unique identifier of the EEC. |
| EEC Context ID | M | Identifier assigned to the EEC Context |
| Source EES | M | The endpoint address (e.g., URI, IP address) |
| Endpoint | | of the EES that provided EEC context ID. |
| UE Identifier | O | The identifier of the hosting UE (i.e., GPSI |
| | | or identity token) |
| List of EDGE-1 | O | List of subscriptions IDs for capability |
| subscriptions | | exposure to the EEC ID (NOTE). |
| UE location | O | Latest UE location of the UE hosting the |
| | | EEC which was available at the EES. |
| List of AC | O | Information about the ACs as described in |
| Profiles | | Table 8.2.2-1. |
| EEC Service | O | Indicates if the EEC supports service |
| Continuity | | continuity or not. The IE also indicates |
| Support | | which ACR scenarios are supported by the |
| | | EEC. |
| Notification | M | The Notification target address (e.g. URL) |
| Target Address | | where the notifications destined for the EEC |
| | | regarding registration updates should be |
| | | sent to. |
| List of Service | O | List of associated Service Session Context |
| Session | | IEs. Each Service Session Context includes |
| Contexts | | information maintained by the EES for the |
| | | services (involving UE related resources) |
| | | received from an EAS registered to the EES. |
| >Service Session | M | Service Session Context is described in |
| Context | | Table 8.2.8-2 |

(NOTE):
The corresponding EDGE-1 subscription information may include 3GPP CN subscription information such as subscription correlation ID

In step 3, the S-EES (300) sends an EEC registration response indicating success or failure of the registration operation. The S-EES (300) may provide an updated expiration time to indicate to the EEC (600) when the registration will automatically expire. To maintain the registration, the EEC (600) shall send a registration update request prior to the expiration time. If a registration update request is not received prior to the expiration time, the EEC (600) shall treat the S-EES (300) as implicitly deregistered.

Steps 1 to 3 are part of EEC registration procedure as specified in clause 8.4.4.2.2 of 3GPP TS 23.558.

In step 4, the EEC (600) performs the EAS discovery procedure (as specified in clause 8.5 of TS 23.558).

In step 5, either the S-EAS decided ACR or the S-EES executed ACR procedure is initiated as specified in clause 8.8.2.4 or clause 8.8.2.5 respectively.

In step 6, the source EES (300) determines to forward EEC context for relocation to a target EES (400). The source EES (300) determines the target and the EEC context to be forwarded.

In step 7, the source EES (300) sends the EEC context push request to the target EES (400) including the EEC context determined. If the request (i.e., EEC context push request) is initiated
a) either after selected T-EAS declaration message from the S-EAS (for S-EAS decided ACR) or after the S-EES (300) determines the T-EES (400) and the T-EAS (200) via the Discover T-EAS procedure (for S-EES executed ACR); or
b) by S-EAS decided ACR or S-EES executed ACR;

The S-EES includes a flag in the request message to indicate the T-EES (400):
a) to implicitly register the EEC (600) for which the EEC context is pushed; or
b) that the EEC (600) (for which the EEC context is pushed) is unaware of context push;
c) about S-EAS (100) or S-EES (300) triggered context push.

Table 6 describes information elements in the EEC Context Push request between two EESs.

TABLE 6

| Information | | |
|---|---|---|
| element | Status | Description |
| EES ID | M | Unique identifier of the requesting EES. |
| Security | M | Security credentials resulting from a |
| credentials | | successful authorization for the edge |
| | | computing service. |
| EEC Context | M | EEC Context |
| flag (NOTE 1) | O | Indicates T-EES that EEC is unaware of |
| | | context push |
| | | Or |
| | | Indicates T-EES to implicitly register the |
| | | EEC for which EEC context is pushed. |
| | | Or |
| | | Indicates T-EES about S-EAS or S-EES |
| | | triggered context push |
| | | Or |
| | | Any other similar indication to indicate |
| | | S-EAS decided ACR scenario or S-EES |
| | | executed ACR scenario |

(NOTE 1):
This IE is included if this request (i.e. EEC context push request) is initiated either after selected T-EAS declaration message from S-EAS or after S-EES determines T-EES and T-EAS via the Discover T-EAS procedure. Or This IE is included when EEC is unaware of EEC context push Or This IE is included when EEC context push is initiated by S-EAS or S-EES. That is this request (i.e. EEC context push request) is initiated for S-EAS decided ACR or S-EES executed ACR scenarios.

In step 8, upon receiving the request from the source EES (300), the target EES (400) validates the request and verifies the security credentials. The target EES (400) uses the EEC Context ID provided to authorize the EEC Context to be stored and managed. Then the target EES (400) sends an EEC Context response indicating success.

If the flag is included in the request message, the T-EES (400) performs implicit registration for the EEC (600) (whose EEC context is received in the request message) and creates the registration ID for the registration. If flag is present in the request message and if implicit registration is success, the target EES (400) includes the implicit registration status in the push EEC context response message. If flag is present in the request message and if implicit registration fails (for any unknown reason), the T-EES (400) includes Implicit Registration status as failed.

Steps 6 to 8 are part of EEC Context Push relocation procedure as specified in clause 8.9.2.3 of 3GPP TS 23.558.

In step 9, the target EES (400) sends notification towards the EEC (600) using notification target address available in the EEC context, and target EES (400) includes implicit registration status. If implicit registration is successful, the target EES (400) also includes the registration ID and expiration time in the notification message.

In an embodiment, the target EES (400) sends notification to the EEC (600) after receiving ACR status from T-EAS (200) indicating successful completion of the ACT.

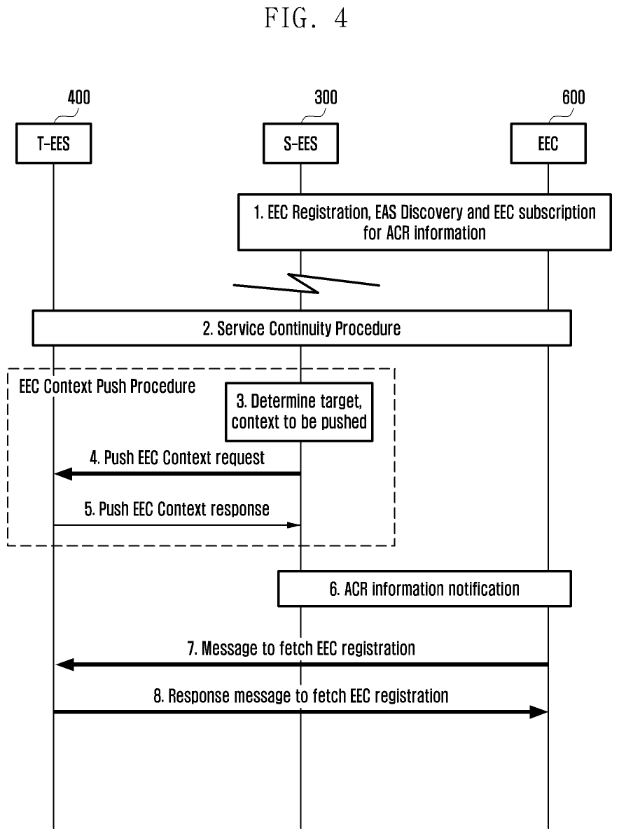

FIG. 4 depicts another various operations to inform new registration details created at T-EES (400) to the EEC (600) by using EEC registration fetch procedure. In step 1, the EEC (600) is registered with S-EES (300) and has discovered the S-EAS (100) from where AC (in the UE (500)) is receiving the service. Further, the EEC (600) has also subscribed for ACR information to the S-EES (300).

In step 2, either the S-EAS decided ACR or the S-EES executed ACR procedure is initiated as specified in clause 8.8.2.4 or clause 8.8.2.5 respectively.

In step 3, the source EES (300) determines to forward the EEC context for relocation to a target EES (400). The source EES (300) determines the target and the EEC context to be forwarded.

In step 4, the source EES (300) sends the EEC context push request to the target EES (400) including the EEC context determined. If the request (i.e., EEC context push request) is initiated,
a) either after selected T-EAS (200) declaration message from the S-EAS (100) (for S-EAS decided ACR) or after the S-EES (300) determines the T-EES (400) and the T-EAS (200) via the Discover T-EAS procedure (for S-EES executed ACR); or
b) by S-EAS decided ACR or S-EES executed ACR;

The S-EES (300) includes a flag in the request message to indicate the T-EES (400):
a) to implicitly register the EEC (600) for which the EEC context is pushed; or
b) that the EEC (600) (for which the EEC context is pushed) is unaware of context push;
c) about S-EAS (100) or S-EES triggered context push.

Table 7 describes information elements in the EEC context push request between two EESs (300) and (400).

TABLE 7

| Information | | |
|---|---|---|
| element | Status | Description |
| EES ID | M | Unique identifier of the requesting EES. |
| Security | M | Security credentials resulting from a |
| credentials | | successful authorization for the edge |
| | | computing service. |
| EEC Context | M | EEC Context |
| flag (NOTE 1) | O | Indicates T-EES that EEC is unaware of |
| | | context push |
| | | Or |
| | | Indicates T-EES to implicitly register the |
| | | EEC for which EEC context is pushed. |
| | | Or |
| | | Indicates T-EES about S-EAS or S-EES |
| | | triggered context push |
| | | Or |
| | | Any other similar indication to indicate |
| | | S-EAS decided ACR scenario or S-EES |
| | | executed ACR scenario |

(NOTE 1):
This IE is included if this request (i.e. EEC context push request) is initiated either after selected T-EAS declaration message from S-EAS or after S-EES determines T-EES and T-EAS (200) via the Discover T-EAS procedure. Or This IE is included when EEC is unaware of EEC context push Or This IE is included when EEC context push is initiated by S-EAS or S-EES. That is this request (i.e. EEC context push request) is initiated for S-EAS decided ACR or S-EES executed ACR scenarios.

In step 5, upon receiving the request from the source EES (300), the target EES (400) validates the request and verifies the security credentials. The target EES (400) uses the EEC context ID provided to authorize the EEC context to be stored and managed. Then the target EES (400) sends an EEC context response indicating success. If the flag is included in the request message, the T-EES (400) performs the implicit registration for the EEC (600) (whose EEC context is received in the request message) and creates the registration ID for the registration. If flag is present in the request message and if implicit registration is success, the target EES (400) includes the implicit registration status in the push EEC context response message. If flag is present in the request message and if implicit registration fails (for any unknown reason), the T-EES (400) includes Implicit Registration status as failed.

Steps 3 to 5 are part of EEC Context Push relocation procedure as specified in clause 8.9.2.3 of 3GPP TS 23.558.

In step 6, the S-EES (300) sends the ACR information notification to the EEC (600) indicating the T-EES information as specified in clause 8.8.3.5.3 of 3GPP TS 23.558. If the S-EES (300) has received the successful Implicit Registration Status from T-EES (400) in the EEC Context Push relocation procedure, the ACR information notification towards EEC (600) also includes the Implicit Registration Status. The S-EES (300) may include the Implicit Registration Status for both target information notification or ACR complete notification or any one of them.

In step 7, after receiving the ACR information (either target information or ACR complete) notification, the EEC (600) may decide to get new EEC registration details if EEC (600) has not previously initiated ACR procedure or successful Implicit Registration Status is included in the notification. The EEC (600) sends a message to the EES (whose details received in target information notification) to fetch the registration details. Table 8 describes information elements in the Message to fetch EEC registration request from the EEC (600) to the EES.

TABLE 8

| Information | | |
|---|---|---|
| element | Status | Description |
| EECID | M | Unique identifier of the EEC. |
| UE | O | The identifier of the hosting UE (500) |
| Identifier | | (i.e. GPSI or identity token) |
| Security | M | Security credentials resulting from a |
| credentials | | successful authorization for the edge |
| | | computing service. |

In step 8, upon receiving the request from the EEC (600), the T-EES (400) validates the registration request and verifies the security credentials. The T-EES (400) further determines whether the EEC registration is expired or not. If the EEC registration has not expired, the T-EES (400) sends a success response with registration details. Otherwise, the EES sends a failure message. If EEC registration does not exist on the EES or the EEC registration is expired, the EES sends response message with appropriate cause. The EES may instruct the EEC (600) to perform explicit registration based on operator policy or implementations. The response message to fetch the EEC registration request from the EES to the EEC includes information elements (as specified in the clause 8.4.2.3.3 of TS 23.558).

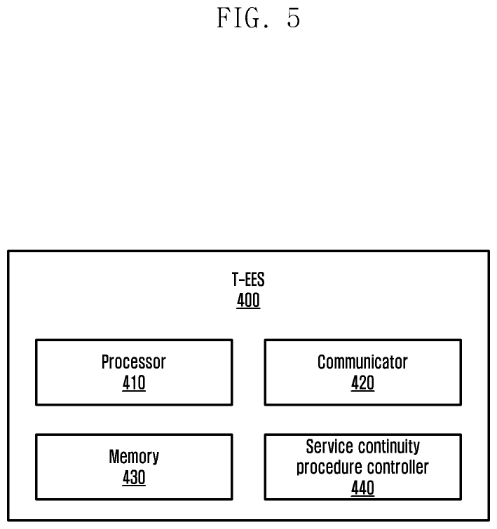

FIG. 5 shows various hardware components of the T-EES (400), according to the embodiments as disclosed herein. In an embodiment, the T-EES (400) includes a processor (410), a communicator (420), a memory (430) and a service continuity procedure controller (440). The processor (410) is coupled with the communicator (420), the memory (430) and the service continuity procedure controller (440).

In an embodiment, the service continuity procedure controller (440) performs the implicit registration of the EEC (600) upon receiving the push EEC context request message from the S-EES (300). Further, the service continuity procedure controller (440) creates at least one of the registration ID associated with the implicit registration and the expiration time associated with the implicit registration of the EEC (600). Further, the service continuity procedure controller (440) adds at least one of the registration ID and the expiration time in the push EEC context response message. Further, the service continuity procedure controller (440) sends the push EEC context response message comprising at least one of the registration ID and the expiration time to the S-EES.

In another embodiment, the service continuity procedure controller (440) performs the implicit registration of the EEC (600) upon receiving the push EEC context request message from the S-EES (300). Further, the service continuity procedure controller (440) creates at least one of the registration ID associated with the implicit registration and the expiration time associated with the implicit registration of the EEC (600). Further, the service continuity procedure controller (440) adds at least one of the registration ID and the expiration time in the notification and sends the notification comprising at least one of the registration ID and the expiration time to the EEC (300) using the notification target address.

In another embodiment, the service continuity procedure controller (440) performs the implicit registration of the EEC (600) upon receiving the push EEC context request message from the S-EES (300). Further, the service continuity procedure controller (440) creates at least one of the registration ID associated with the implicit registration and the expiration time associated with the implicit registration of the EEC (600). Further, the service continuity procedure controller (440) receives at least one message from the EEC (600), where at least one message obtains the update of the registration. Further, the service continuity procedure controller (440) adds at least one of the registration ID and the expiration time in the at least one message. Further, the service continuity procedure controller (440) sends the at least one message comprising at least one of the registration ID, the expiration time and a cause value to the EEC.

The service continuity procedure controller (440) is physically implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (410) is configured to execute instructions stored in the memory (430) and to perform various processes. The communicator (420) is configured for communicating internally between internal hardware components and with external devices via one or more networks. The memory (430) also stores instructions to be executed by the processor (410). The memory (430) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (430) may, in some examples, be considered a non-transitory storage medium. The term “non-transitory” may indicate that the storage medium is not embodied in a carrier wave or a propagated signal. However, the term “non-transitory” should not be interpreted that the memory (430) is non-movable. In certain examples, a non-transitory storage medium may store data that can, over time, change (e.g., in Random Access Memory (RAM) or cache).

Although the FIG. 5 shows various hardware components of the T-EES (400) but it is to be understood that other embodiments are not limited thereon. In other embodiments, the T-EES (400) may include less or more number of components. Further, the labels or names of the components are used only for illustrative purpose and does not limit the scope of the invention. One or more components can be combined together to perform same or substantially similar function in the T-EES (400).

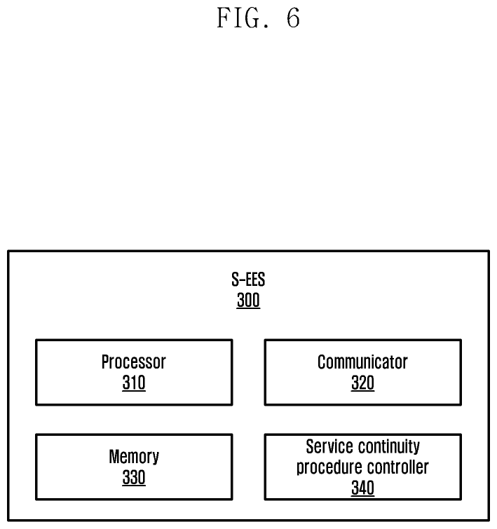

FIG. 6 shows various hardware components of the S-EES (300), according to the embodiments as disclosed herein. In an embodiment, the S-EES (300) includes a processor (310), a communicator (320), a memory (330) and a service continuity procedure controller (340). The processor (310) is coupled with the communicator (320), the memory (330) and the service continuity procedure controller (340).

The service continuity procedure controller (340) sends the push EEC context request message to the T-EES (400). Further, the service continuity procedure controller (340) receives the push EEC context response message comprising at least one of the registration ID associated with the implicit registration of the EEC (600) and the expiration time associated with the implicit registration of the EEC (600) from the T-EES (400) based on the push EEC context request message.

The service continuity procedure controller (340) is physically implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (310) is configured to execute instructions stored in the memory (330) and to perform various processes. The communicator (320) is configured for communicating internally between internal hardware components and with external devices via one or more networks. The memory (330) also stores instructions to be executed by the processor (310). The memory (330) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (330) may, in some examples, be considered a non-transitory storage medium. The term “non-transitory” may indicate that the storage medium is not embodied in a carrier wave or a propagated signal. However, the term “non-transitory” should not be interpreted that the memory (330) is non-movable. In certain examples, a non-transitory storage medium may store data that can, over time, change (e.g., in Random Access Memory (RAM) or cache).

Although the FIG. 6 shows various hardware components of the S-EES (300) but it is to be understood that other embodiments are not limited thereon. In other embodiments, the S-EES (300) may include less or more number of components. Further, the labels or names of the components are used only for illustrative purpose and does not limit the scope of the invention. One or more components can be combined together to perform same or substantially similar function in the S-EES (300).

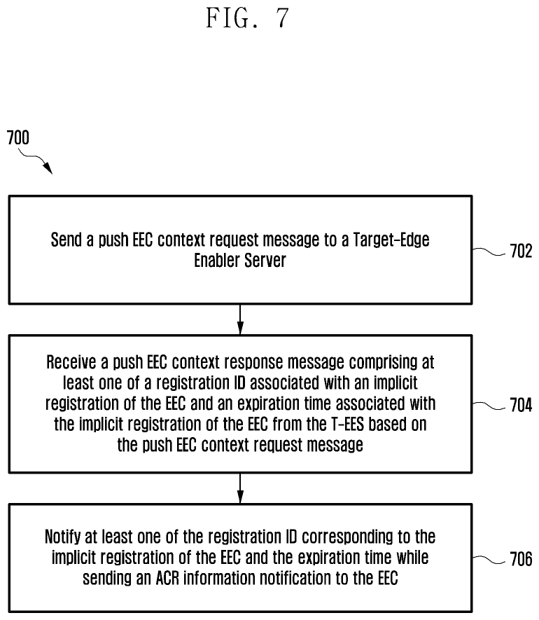

FIG. 7 is a flow chart (700) illustrating a method, implemented by the S-EES (300), for handling the registration of the EEC (600) during the service continuity procedure, according to the embodiments as disclosed herein.

As shown in the FIG. 7, the operations (702-706) are performed by the service continuity procedure controller (340). At 702, the method includes sending the push EEC context request message to the T-EES (400). At 704, the method includes receiving the push EEC context response message comprising at least one of the registration ID associated with the implicit registration of the EEC (600) and the expiration time associated with the implicit registration of the EEC (600) from the T-EES (400) based on the push EEC context request message. At 706, the method includes notifying the registration ID corresponding to the implicit registration of the EEC (600) and the expiration time while sending the ACR information notification to the EEC (600).

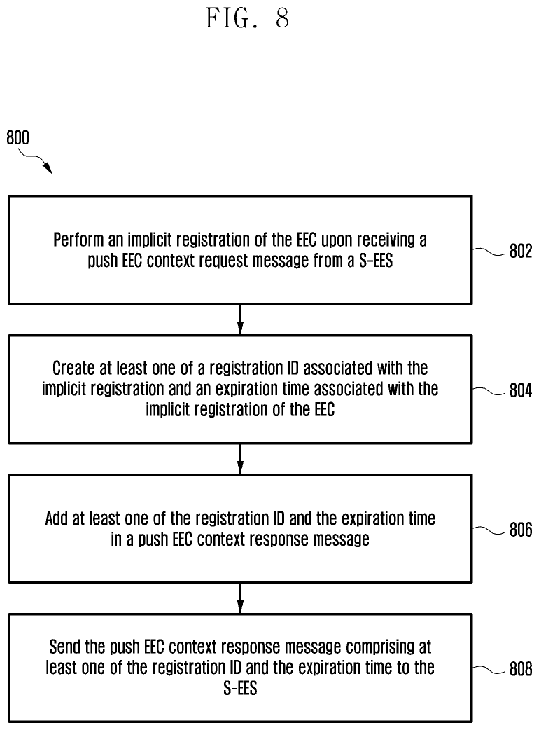

FIG. 8 to FIG. 10 are flow charts (800-1000) illustrating a method, implemented by the, for handling the registration of the EEC (600) during the service continuity procedure, according to the embodiments as disclosed herein.

As shown in the FIG. 8, the operations (802-808) are performed by the service continuity procedure controller (440). At 802, the method includes performing the implicit registration of the EEC (600) upon receiving the push EEC context request message from the S-EES (300). At 804, the method includes creating at least one of the registration ID associated with the implicit registration and the expiration time associated with the implicit registration of the EEC (600). At 806, the method includes adding at least one of the registration ID and the expiration time in the push EEC context response message. At 808, the method includes sending the push EEC context response message comprising at least one of the registration ID and the expiration time to the S-EES (300).

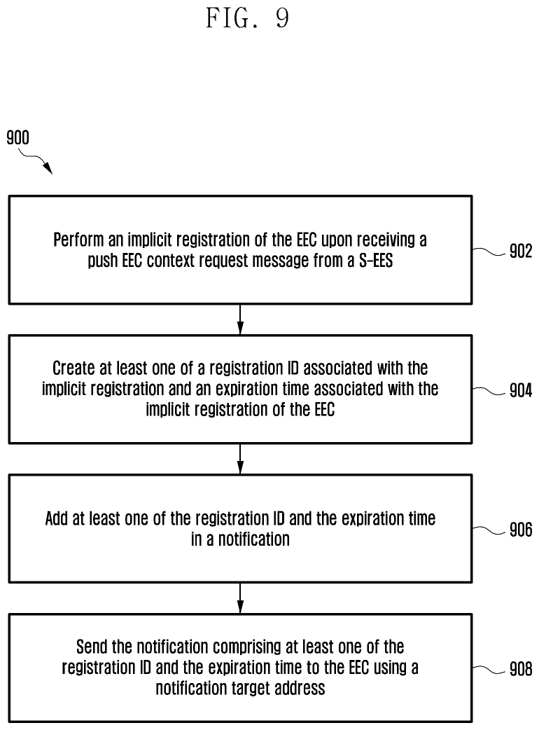

As shown in the FIG. 9, the operations (902-908) are performed by the service continuity procedure controller (440). At 902, the method includes performing the implicit registration of the EEC (600) upon receiving a push EEC context request message from the S-EES (300). At 904, the method includes creating at least one of a registration ID associated with the implicit registration and the expiration time associated with the implicit registration of the EEC (600). At 906, the method includes adding at least one of the registration ID and the expiration time in the notification. At 908, the method includes sending the notification comprising at least one of the registration ID and the expiration time to the EEC (600) using the notification target address.

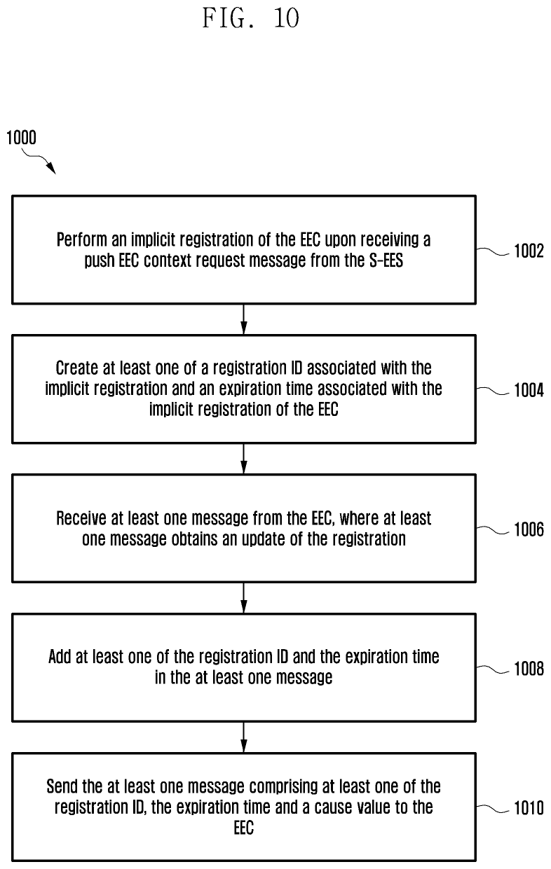

As shown in the FIG. 10, the operations (1002-1010) are performed by the service continuity procedure controller (440). At 1002, the method includes performing the implicit registration of the EEC upon receiving the push EEC context request message from the S-EES (300). At 1004, the method includes creating at least one of a registration ID associated with the implicit registration and the expiration time associated with the implicit registration of the EEC (600). At 1006, the method includes receiving at least one message from the EEC (600), wherein at least one message obtains an update of the registration. At 1008, the method includes adding at least one of the registration ID and the expiration time in the at least one message. At 1010, the method includes sending the at least one message comprising at least one of the registration ID, the expiration time and the cause value to the EEC.

The various actions, acts, blocks, steps, or the like in the flow charts (S800-S1000) may be performed in the order presented, in a different order or simultaneously. Further, in some embodiments, some of the actions, acts, blocks, steps, or the like may be omitted, added, modified, skipped, or the like without departing from the scope of the invention.

The embodiments disclosed herein can be implemented through at least one software program running on at least one hardware device and performing network management functions to control the elements. The elements can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

1-15. (canceled)

16. A method performed by a Target-Edge Enabler Server (T-EES) (400) during a service continuity procedure, the method comprising:
performing an implicit registration of the Edge Enabler Client (EEC) (600) upon receiving a push EEC context request message from a Source-Edge Enabler Server (S-EES) (300);
creating a registration identifier (ID) associated with the implicit registration; and
sending, to the S-EES (300), a push EEC context response message including at least one of the registration ID and an expiration time.

17. The method as claimed in claim 16, wherein the registration ID corresponds to a registration of the EEC (600) and the expiration time indicates an expiration time of the registration of the EEC (600).

18. The method as claimed in claim 16,
wherein an Application Context Relocation (ACR) information notification is sent from the S-EES (300) to an edge enabler client (EEC) (600).

19. The method as claimed in claim 18, wherein the ACR information notification includes the registration ID and the expiration time in case that the S-EES has received a successful EEC Context Push response from the T-EES.

20. A method performed by a Source-Edge Enabler Server (S-EES) (300) during a service continuity procedure, the method comprising:
sending, to a Target-Edge Enabler Server (T-EES) (400), a push EEC context request message; and
receiving, from the T-EES (400) a push EEC context response message including at least one of a registration identifier (ID) associated with an implicit registration of the EEC (600) and an expiration time associated with the implicit registration of the EEC (600) based on the push EEC context request message.

21. The method as claimed in claim 20, wherein the registration ID corresponds to a registration of the EEC (600) and the expiration time indicates an expiration time of the registration of the EEC (600).

22. The method as claimed in claim 20, further comprising:
sending, to an edge enabler client (EEC) (600), an Application Context Relocation (ACR) information notification.

23. The method as claimed in claim 22, wherein the ACR information notification includes the registration ID and the expiration time in case that the S-EES has received a successful EEC Context Push response from the T-EES.

24. A Target-Edge Enabler Server (T-EES) (400) for handling a registration of an edge enabler client (EEC) (600) during a service continuity procedure, comprising:
a processor (410);
a memory (430); and
a service continuity procedure controller (440), coupled with the processor (410) and the memory (430), configured to:
perform an implicit registration of the EEC (600) upon receiving a push EEC context request message from a Source-Edge Enabler Server (S-EES) (300);
create at least one of a registration identifier (ID) associated with the implicit registration; and
send, to the S-EES (300), a push EEC context response message including at least one of the registration ID and an expiration time.

25. The T-EES as claimed in claim 24, wherein the registration ID corresponds to a registration of the EEC (600) and the expiration time indicates an expiration time of the registration of the EEC (600).

26. The T-EES as claimed in claim 24,
wherein an Application Context Relocation (ACR) information notification is sent from the S-EES (300) to an edge enabler client (EEC) (600).

27. The T-EES as claimed in claim 26, wherein the ACR information notification includes the registration ID and the expiration time in case that the S-EES has received a successful EEC Context Push response from the T-EES.

28. A Source-Edge Enabler Server (S-EES) (300) for handling a registration of an edge enabler client (EEC) (600) during a service continuity procedure, comprising:
a processor (310);
a memory (330); and
a service continuity procedure controller (340), coupled with the processor (310) and the memory (330), configured to:
send, to a Target-Edge Enabler Server (T-EES) (400), a push EEC context request message; and
receive, from the T-EES (400), by the, a push EEC context response message including at least one of a registration identifier (ID) associated with an implicit registration of the EEC (600) and an expiration time associated with the implicit registration of the EEC (600) based on the push EEC context request message.

29. The S-EES as claimed in claim 28, wherein the registration ID corresponds to a registration of the EEC (600) and the expiration time indicates an expiration time of the registration of the EEC (600).

30. The S-EES as claimed in claim 28,
wherein the processor is further configured to:
send, to an edge enabler client (EEC) (600), an Application Context Relocation (ACR) information notification, and
wherein the ACR information notification includes the registration ID and the expiration time in case that the S-EES has received a successful EEC Context Push response from the T-EES.
